(19) United States
(12) Patent Application Publication
(10) Pub. No.: US 2012/0126626 A1
(43) Pub. Date: May 24, 2012

(54) DEVICE FOR SUPPLYING ELECTRICAL ENERGY FROM A PLURALITY OF STRINGS OF PHOTOVOLTAIC MODULES TO A POWER GRID

(75) Inventors: Andreas Falk, Kassel (DE); Jan Goldau, Kaufungen (DE); Gerold Schulze, Kassel (DE); Jochen Fischer, Baunatal (DE)

(73) Assignee: SMA Solar Technology AG, Niestetal (DE)

(21) Appl. No.: 13/363,733

(22) Filed: Feb. 1, 2012

Related U.S. Application Data
(63) Continuation of application No. PCT/EP2010/061304, filed on Aug. 3, 2010.

(30) Foreign Application Priority Data
Aug. 6, 2009 (EP) 09167414.3

(51) Int. Cl. H02J 1/00

(52) U.S. Cl. 307/80

(57) ABSTRACT

In a device for supplying electrical energy from a plurality of strings of photovoltaic modules to a power grid that includes a connection terminal for each string of the plurality of strings, wherein each connection terminal includes an over-current protection component including a power switch for selectively disconnecting the respective string. The device further includes a central insulation monitoring unit providing an insulation status of the entire plurality of strings, and the power switch of each over-current protection component includes an all-pole disconnecting power switch that can be opened and closed by a controller via a motor in response to the insulation status provided by the central insulation monitoring unit to select and selectively disconnect a string having an insulation failure. The device is further configured to supply electrical energy from the remaining strings of the plurality of strings having no insulation failure.

### CROSS-REFERENCE TO RELATED APPLICATIONS

This application is a continuation application of PCT/EP2010/061304, filed on Aug. 3, 2010, which claims priority to co-pending European Patent Application No. 09 167 414.3 entitled “Vorrichtung zur Einspeisung elektrischer Energie von einer Vielzahl von Strings von Photovoltaikmodulen in ein Stromnetz”, filed on Aug. 6, 2009.

### FIELD

The invention relates to a device for supplying electrical energy from a plurality of strings of photovoltaic modules to a power grid.

### BACKGROUND

Regarding a current product of the assignee that is designed to supply electrical energy from a plurality of strings of photovoltaic modules to a power grid, thermal fuses are included for each of the multiple connectable strings for protection against over-current conditions. Also included is a central DC load disconnecting switch for the current that flows from all strings. The individual substrings are monitored for breakdown by local monitoring devices that are installed on site. Signal transmission channels, usually signal transmission lines, must be provided between these local devices and the central device. In the event that a central mechanism for recording the insulation status of the various strings detects an insulation failure, only the whole device and/or the central DC load disconnecting switch can be opened. If a string with incorrect polarity is connected to the known device, the corresponding thermal fuse will burn out as it is unable to switch the double open-circuit voltage that drops across it in a standard circuit layout.

A further device for supplying electrical energy from a plurality of strings of photovoltaic modules to a power grid is known as a Siemens product partially described by Brigitte Schulz: “PV-Erdung, Technische Beschreibung”, Siemens-Document SINVERT_pv field grounding_technical_{—}2009_{—}02-09.doc. More specifically, this product is a 500 kW inverter with four 125 kW strings connected to it over a separate load disconnecting switch and DC contactor so that it can be switched on and off selectively. A GFDI is provided as the central mechanism for recording the insulation status. This circuit breaker trips when a ground fault occurs, for example, somewhere near the photovoltaic modules. In response, the known device will switch to an insulated operating mode to prevent high ground currents. In the following night, an automatic insulation measurement is performed where the photovoltaic modules are located. After the error is identified and attributed to a specific string, the device will return to the ground operating mode on the following day and the DC contactor for the string affected by the ground fault will remain open.

Patent Application Publication US 2007/0107767 A1 discloses a DC power-generator system and integral control apparatus therefore. A DC power-generation array system is made up of an array of power-generation cells arranged as N strings of M cells each. The system incorporates an integral control apparatus having N string units and a single process unit. Each string unit is coupled to one of the strings, and is made up of a monitor module to measure a string current through that string, and a switching module to switch that string into and out of the array. The process unit is made up of a processor to evaluate the string currents, and a data I/O module to provide a remote monitoring and control of the system. The system also has an interface unit to provide local monitoring and control of the system. The processor causes the switching modules to couple or decouple strings from array under automatic, remote, and/or local control. Each switching module is configured to electrically switch the associated string into and out of the array, and comprises a switch capable of electrically coupling and decoupling the string from the array, i.e., to effect connection and disconnection of the string from a summing bus. In its simplest form, the switch may be a simple single-pole, single-throw switch or a relay serving only to connect and disconnect the string from array.

Patent Application Publication US 2006/0237058 A1 discloses a direct current combiner box with power monitoring, ground fault detection and communications interface. The combiner box is used to collect direct current from solar panels or other energy sources. The combiner box integrates all means necessary for ground fault detection, current monitoring, voltage monitoring, and power monitoring. These means include separate fuses, DC current sensors and controlled single-throw switches for each solar panel.

There still is a need for a device for supplying electrical energy from a plurality of strings of photovoltaic modules to a power grid that allows for yield optimization for the electrical energy fed into the power grid while at the same time ensuring high operating reliability and low costs for the overall assembly of the photovoltaic system when the device is used.

### SUMMARY

In an aspect, the present invention provides a device for supplying electrical energy from a plurality of strings of photovoltaic modules to a power grid, which comprises a connection terminal for each string of the plurality of strings, each connection terminal comprising over-current protection means including a power switch for selectively disconnecting the respective string, and a central insulation monitoring unit providing an insulation status of the entire plurality of strings. Here, the power switch of each over-current protection means is an all-pole disconnecting power switch that is opened and closed by a controller via a motor in response to the insulation status provided by the central insulation monitoring unit to select and selectively disconnect a string having an insulation failure, and to further supply electrical energy from the remaining strings of the plurality of strings having no insulation failure.

In a further aspect, the present invention provides a use of the device according to the present invention in which the number of connection terminals is 30 at a minimum with strings each having 20 substrings at a minimum.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention will be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic one-line diagram of the device for supplying electrical energy from a plurality of strings of photovoltaic modules to a power grid; and

FIG. 2 illustrates in greater detail one connection terminal for one string of the device of FIG. 1.

### DETAILED DESCRIPTION

The individual strings that are connected to such a device may not only comprise a serial connection, or “string”, of photovoltaic modules but also have multiple substrings that are combined into a parallel connection on site, i.e., on or near the site of the photovoltaic modules.

All parts of the device to which the present invention pertains are concentrated locally, i.e., centralized in contrast to the various strings and substrings which are, due to the extension of their active surface, distributed over a rather large area. All parts of the device may be contained in one central enclosure. But that does not necessarily have to be the case. As an alternative, the device may consist of individual modules for which individual enclosures are provided. These individual enclosures are also provided in one central location of the device and are not intended for on-site assembly with the photovoltaic modules.

A device to which the present invention pertains is typically designed to supply electrical energy to an AC power grid and thus contains an inverter. This inverter may be combined with step-up converters, step-down converters (DC/DC and/or AC/AC converters) and transformers in almost any manner to ensure that its output voltage matches the grid voltage of the AC power grid.

The present invention addresses the need to safeguard the individual strings and the electrical energy supply device from errors, especially insulation failures, in the area of the strings and their supply lines to the device.

In the new device, the over-current protection component provided in each connection terminal for each string include a power switch that can be opened and closed by a motor. This power switch protects its respective string and can be selectively connected and disconnected if there is evidence of an error in the area of one of its substring or of its supply lines to the device. These errors may be errors that are registered by the central mechanism for recording the insulation status of the various strings or they may involve errors that are detected in some other way. In one embodiment, this form of error detection will exclusively take place within the new device itself. This means that no errors will be detected on site and then communicated to the device, but instead detected in the device so that they do not have to be communicated to the device. The over-current protection component basically comprises a low-cost power switch, which has a limited current-carrying capacity, may make it necessary to divide the current and to thus distribute the power over a comparatively large number of strings so that each string only supplies current that can actually be carried by one of these power switches. This also means that the number of supply lines from the system site based on the number of strings may be comparatively large. These disadvantages, however, are far outweighed by the advantages that the new device offers. If an error occurs in the area of a string, disconnecting that string via its power switch will have little effect on the overall performance of the photovoltaic system due to the larger number of strings. As they are only intended to carry relatively small current, the supply lines from the individual strings to the new device do not require a large cross-section and are thus inexpensive to design and easy to install. Moreover, communication lines, which are usually present parallel to the current-carrying connection lines, are no longer necessary when using the new device.

More specifically, a controller of the new device operates the power switches in the connection terminals of the various strings via motors depending on what insulation status of the entire plurality of strings a central insulation monitoring unit provides.

In the new device, each power switch disconnects its corresponding string at all poles (i.e., it completely isolates them) when the power switch opens. This is necessary to safely eliminate an insulation failure in a string so that it does not affect the rest of the photovoltaic system.

In accordance with the invention, any insulation failure that occurs is responded to immediately (i.e., on the same day while the photovoltaic modules are operating) with the goal of selecting the string that caused the insulation error and then disconnecting that string by opening its power switch via a motor.

For the purpose stated above, when an isolation failure occurs the controller may at first open all of the power switches and then selectively close them in order to localize the insulation failure, which the central device can only detect as such, to one of the individual strings. The power switches can be closed again individually or based on known quick selection methods in variable groups.

Depending on how the central insulation monitoring unit is designed (e.g., as a GFDI, a soft-grounding device or a device for monitoring ground faults through measuring the insulation resistance), it may be necessary for the controller of the new device to reset this central insulation monitoring unit prior, to the motor-driven closing of all the power switches so that it gets in the position to detect new insulation errors. The same applies with the central insulation monitoring unit when an insulation failure has been attributed to a group of strings because it has reoccurred when the relevant power switch is closed and the actual string affected by the error needs to be further localized.

In one embodiment the over-current protection component for each string comprises a power sensor in addition to the power switch. These power sensors may be used to detect a power failure in the substring of one of the strings by monitoring the currents that flow into the device from the individual strings, particularly in view of the grouping of these currents, even if this string has a comparatively large number of substrings connected in parallel. This type of monitoring can be based, for example, on how the current from the respective string behaves in comparison to the currents from other strings. The preconditions for carrying out such procedures are excellent in the new device because the large number of strings provides a large number of reference values and makes the elimination of statistical errors very effective.

Moreover, if each power sensor in the new device is direction-sensitive, a reverse current can be detected which, in turn, indicates an error in the area of the string that is connected here, or a reversed polarity of its connection to the new device. Whereas a reversed polarity error can quickly give rise to a current that is so large that the power switch opens as a result of its integrated protective function, other errors causing smaller reverse currents are only detected by the power sensor.

To safely accommodate reversed polarity errors, the power switches in the new device are designed at least for the double open-circuit voltage of the strings. This is comparatively easy to implement and eliminates any danger of burn-off in connection with the reverse polarity errors.

As previously suggested, in one embodiment only connectors for the connection cables that carry the power current are provided for each string in the new device (i.e., no additional connectors for some communication cables). There is also no wireless signal transmission parallel to the connection cables that carry the power current.

The number of connection terminals of the new device is usually 5 at minimum, preferably 10 at minimum, more preferably 20 at minimum and most preferably 30 at minimum in one embodiment. The new device is therefore designed for a relatively large number of individual strings that are connected to the device in parallel to each other.

The new device is particularly well-suited for use with strings of which each individual string has a minimum of 10 substrings, preferably a minimum of 20 substrings, more preferably a minimum of 30 substrings and most preferably a minimum of 50 substrings in one embodiment. As compared to other designs, these are large numbers of substrings when one considers that they are not individually monitored on site. Instead, in the use of the new device, it is preferred that all the substrings of a string were simply connected together on site. Each substring will, however, normally be protected by an individual over-current protection device, i. e. an over-current fuse.

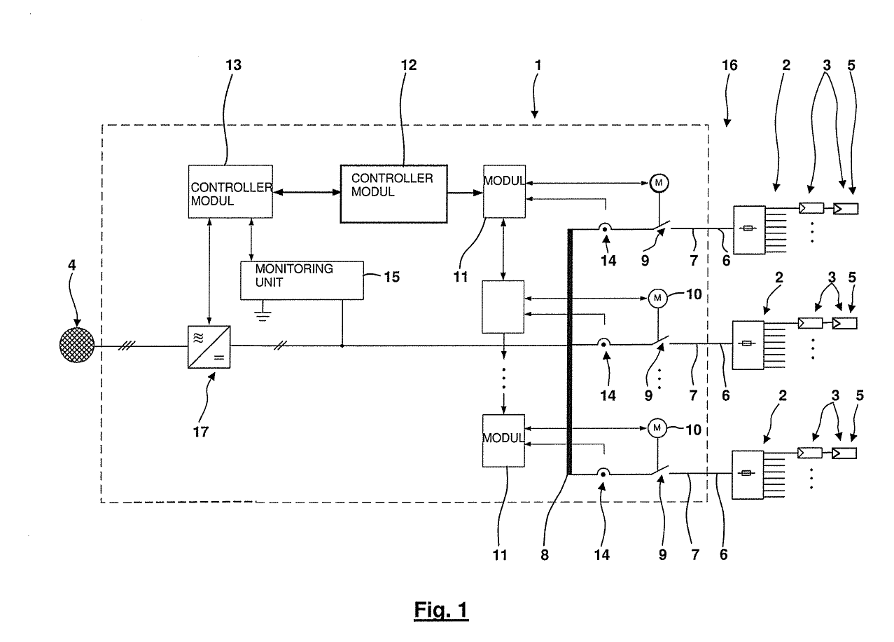

Referring now in greater detail to the drawings, in which one embodiment of the invention is shown, FIG. 1 illustrates a device 1 for supplying electrical energy from various strings 2 of solar modules 3 to a power grid 4, which in this case is an AC power grid. The actual device 1 is encircled by a dashed line in FIG. 1, and may be enclosed in a single enclosure. In any case, the components of the device 1, which are encircled by the dashed line, are provided at a central location in one embodiment, and are not locally distributed on site for the photovoltaic modules 3. Each string 2 not only includes a serial connection of photovoltaic modules 3, but also multiple substrings 5 that are combined on site (the individual substrings 5 are protected by fuses) so that only the current-carrying connection cables 6 of each string 2 are routed from the system site to the device 1. A connection terminal 7 to the device 1 is provided for each string 2 to which only one string 2 is connected before the currents from all the strings 2 are combined on a shared bus cable 8. A power switch 9 that can be opened and closed via a motor 10 is provided in each connection terminal 7. The motor 10 is activated by a module 11 of a controller of the device 1 that is assigned to the relevant connection terminal 7. FIG. 1 does not show that each power switch 9 additionally has an integrated mechanism which automatically opens the power switch 9 if an over-current exceeds a predefined threshold. Additionally, a direction-sensitive power sensor 14 is provided in each connection terminal 7. If this sensor registers a reversed current to the relevant string 2, the corresponding module 11 of the control unit opens the power switch 9 via the motor 10, even if the internal over-current protection device of the power switch 9 has not been activated yet. Moreover, the power sensors 14 are used in unison to monitor the string 2 for a failure in the individual substrings 5. To this end, the collective of currents flowing from the strings 2 and measured by the power sensors 14 are observed and analyzed. This takes place in a central module 12 of the controller in the device 1. The device 1 also has a central insulation monitoring unit 15 for recording the insulation status of the overall photovoltaic system 16 shown in FIG. 1, including the strings 2. This monitoring unit 15 may, for example, be a GFDI, a “soft-grounding” device or a device for monitoring ground faults by measuring the insulation resistance. If an insulation failure is registered by the monitoring unit 15, it will send a notification to a module 13 of the controller in the device 1. In response, this module 13 can stop a central inverter 17 in the device 1 or at least influence its operation until the insulation failure is localized. If the insulation failure occurs in the area of one of the strings 2, it can be detected by initially having the controller 11-13 open all the power switches 9. At this point, the central insulation monitoring unit 15, which may have to be reset in the case of a GFDI or a soft-grounding device, should no longer display the insulation failure. Otherwise the failure is not in the area of the strings 2, but in a different location. If the insulation failure is no longer displayed, then the error can finally be attributed to a single string 2 by selectively closing the power switches 9 either individually or in groups. This string 2 can be “grouped out” or disconnected by opening the corresponding power switch 9 and the remaining strings 2 can continue to supply electrical energy to the grid 4 without any adverse effects. This selection of the error-affected string 2 is made by the controllers 11 through 13 while the photovoltaic system 16 is operating, i.e., while voltage from the strings 2 is applied to the device 1. The device 1 can thus return to normal operation in a very short period of time and supply electrical energy to the grid 4. The losses caused by the failure in string 2 should remain minor, especially if a comparably large number of strings 2 are parallel connected to the device 1 via one power switch 9 each.

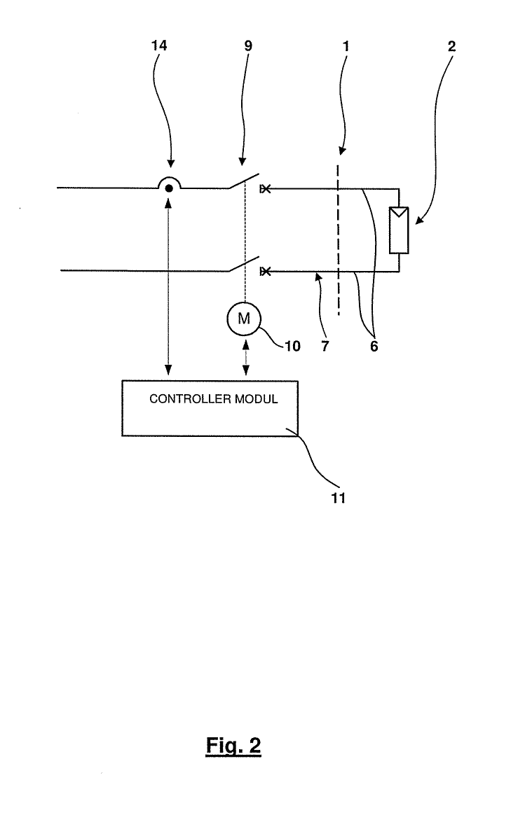

FIG. 2 contains the layout of a connection terminal 7 of the device 1 as per FIG. 1 in a two-line diagram which clearly shows how the power switch 9 disconnects the string 2 at all poles (note that this string is only represented schematically here). The power switch 9 is designed for the double open-circuit voltage of the string 2 so that it is capable of disconnecting a string 2 that is connected to the device 1 with the incorrect polarity, whereby the double open-circuit voltage is applied via the contacts of the power switch 9.

Many variations and modifications may be made to the preferred embodiments of the invention without departing substantially from the spirit and principles of the invention. All such modifications and variations are intended to be included herein within the scope of the present invention, as defined by the following claims.

1. A device for supplying electrical energy from a plurality of strings of photovoltaic modules to a power grid, the device comprising:
a connection terminal configured to couple to a respective string of the plurality of strings, wherein each connection terminal comprises an over-current protection component including a power switch configured to selectively disconnect the respective string, and
a central insulation monitoring unit configured to provide an insulation status of the entire plurality of strings;
wherein the power switch of each over-current protection component comprises an all-pole disconnecting power switch configured to be opened and closed by a controller via a motor in response to the insulation status provided by the central insulation monitoring unit to select and selectively disconnect a string having an insulation failure, and to further supply electrical energy from the remaining strings of the plurality of strings having no insulation failure.

2. The device of claim 1, wherein the controller is configured to select the string that has an insulation failure based on the insulation status and opens the associated power switch via the motor while the photovoltaic modules of the plurality of strings are operating.

3. The device of claim 1, wherein, if the insulation monitoring unit provides an insulation status indicating an insulation failure of any of the strings of the plurality of strings, the controller first opens the power switches of all the over-current protection means, and then selectively re-closes the power switches one at a time to identify one or more strings individually that actually have an insulation failure.

4. The device of claim 3, wherein the controller is configured to re-close the power switches individually.

5. The device of claim 3, wherein the controller is configured to re-close the power switches in groups.

6. The device of claim 1, wherein the over-current protection component of each connection terminal comprises the respective power switch and a power sensor.

7. The device of claim 6, further comprising a monitoring device configured to monitor the current measured by each power sensor for an indication of breakdown of a substring of the corresponding string.

8. The device of claim 6, wherein the power sensor is direction-sensitive.

9. The device of claim 8, wherein the controller is configured to open the respective power switch via the motor whenever the respective power sensor registers a reversed current.

10. The device of claim 1, wherein each power switch is configured for at least 200% of an open-circuit voltage of a respective string.

11. The device of claim 1, wherein each connection terminal only comprises connectors for connection cables of the associated string that carry its power current.

12. The device of claim 1, wherein a number of connection terminals is at least 5.

13. The device of claim 1, wherein a number of connection terminals is at least 10.

14. The device of claim 1, wherein a number of connection terminals is at least 20.

15. The device of claim 1, wherein a number of connection terminals is at least 30.

16. A use of the device of claim 1, wherein each string has at least 10 substrings.

17. The use of claim 16, wherein each string has at least 20 substrings.

18. The use of claim 16, wherein each string has at least 40 substrings.

19. The use of claim 16, wherein each string has at least 50 substrings.

20. The use of claim 16, wherein all the substrings of a string are interconnected on site, each substring being secured via an over-current fuse.
